(19) United States
(12) Patent Application Publication
(10) Pub. No.: US 2015/0286279 A1
(43) Pub. Date: Oct. 8, 2015

(54) SYSTEMS AND METHODS FOR GUIDING A USER DURING CALIBRATION OF A SENSOR

(71) Applicant: InvenSense, Incorporated, San Jose, CA (US)

(72) Inventors: James Lim, Saratoga, CA (US); Shang-Hung Lin, San Jose, CA (US); Alexey Morozov, Sunnyvale, CA (US)

(73) Assignee: InvenSense, Incorporated, San Jose, CA (US)

(21) Appl. No.: 14/247,150

(22) Filed: Apr. 7, 2014

(51) Int. Cl. G06F 3/01; G06F 3/0487

(52) U.S. Cl. CPC G06F 3/017; G06F 3/0487

(57) ABSTRACT

This disclosure provides techniques for guiding a user through a calibration operation of a mobile device having a motion sensor. The user may receive one or more visual cues to aid the user in positioning the device in one or more desired orientations or patterns of motion. The visual cues may be with respect to a virtual three dimensional environment that is responsive to a determined orientation of the device.

### FIELD OF THE PRESENT DISCLOSURE

This disclosure generally relates to the calibration of sensors and more specifically providing a user a graphical interface to facilitate calibration.

### BACKGROUND

The development of microelectromechanical systems (MEMS) has enabled the incorporation of a wide variety of sensors into mobile devices, such as cell phones, laptops, tablets, gaming devices and other portable, electronic devices. Non-limiting examples of such sensors include an accelerometer, a gyroscope, a magnetometer, a pressure sensor, a microphone, a proximity sensor, an ambient light sensor, an infrared sensor, and the like. Further, sensor fusion processing may be performed to combine the data from a plurality of sensors to provide an improved characterization of the device's motion or orientation. However, due to the nature of electronics and mechanics, MEMS-based sensors may be prone to having bias (offset) and sensitivity errors. These errors may drift and or change due to temperature, humidity, time, assembly stress and other changes in peripheral conditions. In turn, inaccurate bias may result in decreased quality of sensor data and may complicate the sensor fusion process used to estimate parameters such as attitude (e.g., pitch, roll, and yaw), heading reference and the like which are dependent on the precision of the sensors' outputs. For example, when integration of raw data output by the sensor is used to determine velocity from acceleration or orientation angle from the rate of angular change, the bias drift problem may be significantly magnified.

In light of these characteristics of MEMS sensors, it may be desirable to perform a sensor calibration operation to characterize the bias or sensitivity error, enabling a correction of the sensor data. A sensor calibration operation may employ mathematical calculations to deduce various motion states and the position or orientation of a physical system. A sensor bias may be produced by the calibration operation, which may then be applied to the raw sensor data and calibrate the sensor. As will be appreciated, the calibration operation may be performed during manufacture or may be performed periodically while the device is being used to account for changes that may occur over time.

Accordingly, performing a calibration operation may be used to improve the quality of data obtained from the sensor. Depending on the characteristics of the sensor being calibrated, the calibration operation may be facilitated by positioning the device in one or more specific orientations or moving the device in a particular pattern of motion. However, even if a user has knowledge of the orientations or patterns, it may be difficult to accurately reproduce them. Further, a user may not be aware when a calibration operation has been successfully completed. To address these needs, this disclosure is directed to systems and methods for guiding a user during a calibration process to position the device in one or more desired orientations or to move the device in a desired pattern of motion and to provide feedback regarding when the desired orientation or movement has been achieved and calibration has been completed.

### SUMMARY

This disclosure is directed to a method for calibrating a motion sensor of a device and may include generating a virtual three dimensional environment, displaying a first visual cue to a user with respect to the virtual three dimensional environment configured to guide the user to position the device in a first desired orientation and providing an indication to the user when the device is positioned in the first desired orientation. The virtual environment may be updated in response to the user moving the device to the first desired orientation. At least a second visual cue may also be displayed to guide the user to move the device from the first desired orientation to a second desired orientation. Accordingly, a plurality of visual cues may be configured to guide the user to position the device in a sequence of desired orientations and the sequence of desired orientations may result in a desired pattern of motion.

In one aspect, the desired pattern of motion may result from complete rotations in three degrees of freedom.

In one embodiment, the motion sensor may be an accelerometer and the desired pattern of motion may incorporate relatively slow rotation around at least two axes of the device with periodic periods of motionlessness.

In one embodiment, the motion sensor may be a magnetometer and the desired pattern of motion may incorporate rotation around at least two axes of the device.

In one embodiment, the motion sensor may be a gyroscope and the desired pattern of motion may include a period of motionlessness in the first desired orientation. Alternatively or in addition, the desired pattern of motion may incorporate rotation around three axes of the device with periods of motionlessness.

In one embodiment, an indication may be provided to the user when the device is sufficiently calibrated.

In one embodiment, the virtual three dimensional environment may be a panorama.

In one embodiment, the first visual cue may be a target object within the virtual three dimensional environment.

In one embodiment, the first visual cue may be an object within the virtual three dimensional environment that moves in response to an orientation of the device.

This disclosure also includes a sensor system, such that the system includes a device having at least one motion sensor and a guidance module configured to generate a virtual three dimensional environment, display a first visual cue to a user with respect to the virtual three dimensional environment configured to guide the user to position the device in a first desired orientation and provide an indication to the user when the device is positioned in the first desired orientation. The guidance module may update the virtual environment in response to the user moving the device to the first desired orientation. The guidance module may also display at least a second visual cue to guide the user to move the device from the first desired orientation to a second desired orientation. The guidance module may also display a plurality of visual cues configured to guide the user to position the device in a sequence of desired orientations. The sequence of desired orientations may result in a desired pattern of motion.

In one aspect, the desired pattern of motion may result from complete rotations in three degrees of freedom.

In one embodiment, the motion sensor may be an accelerometer and the desired pattern of motion may incorporate relatively slow rotation around at least two axes of the device with periodic periods of motionlessness.

In one embodiment, the motion sensor may be a magnetometer and the desired pattern of motion may incorporate rotation around at least two axes of the device.

In one embodiment, the motion sensor may be a gyroscope and the desired pattern of motion may include a period of motionlessness in the first desired orientation. Alternatively or in addition, the desired pattern of motion may incorporate rotation around three axes of the device with periods of motionlessness.

In one embodiment, the guidance module may provide an indication to the user when the device is sufficiently calibrated.

In one embodiment, the virtual three dimensional environment may be a panorama.

In one embodiment, the first visual cue may be a target object within the virtual three dimensional environment.

In one embodiment, the first visual cue may be an object within the virtual three dimensional environment that moves in response to an orientation of the device.

### BRIEF DESCRIPTION OF THE DRAWINGS

FIG. 1 is a block diagram of a system that utilizes a guidance module in accordance with an embodiment.

FIG. 2 depicts a flow chart representing the guiding of a calibration operation in accordance with an embodiment.

FIGS. 3 and 4 are schematic representations of targeting in a virtual three dimensional environment in accordance with an embodiment.

FIG. 5 schematically depicts a sequence of images representing movement of an object in a virtual three dimensional environment in accordance with an embodiment.

FIG. 8 is a schematic representations of a panoramic image in a virtual three dimensional environment in accordance with an embodiment.

FIG. 9 is a a schematic diagram of the orientation of a device with respect to gravity according to an embodiment.

FIGS. 10-12 are schematic representations of movement of an object in a virtual three dimensional environment in accordance with another embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a motion tracking module also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. In the described embodiments, a MPU may include processors, memory, control logic and sensors among structures.

As will be described more fully below, this disclosure provides techniques for guiding a user through a calibration operation for a mobile device having a motion sensor. The user may receive one or more visual cues to facilitate positioning the device in one or more desired orientations or producing one or more patterns of motion. The visual cues may be with respect to a virtual three dimensional environment that is responsive to a determined orientation of the device.

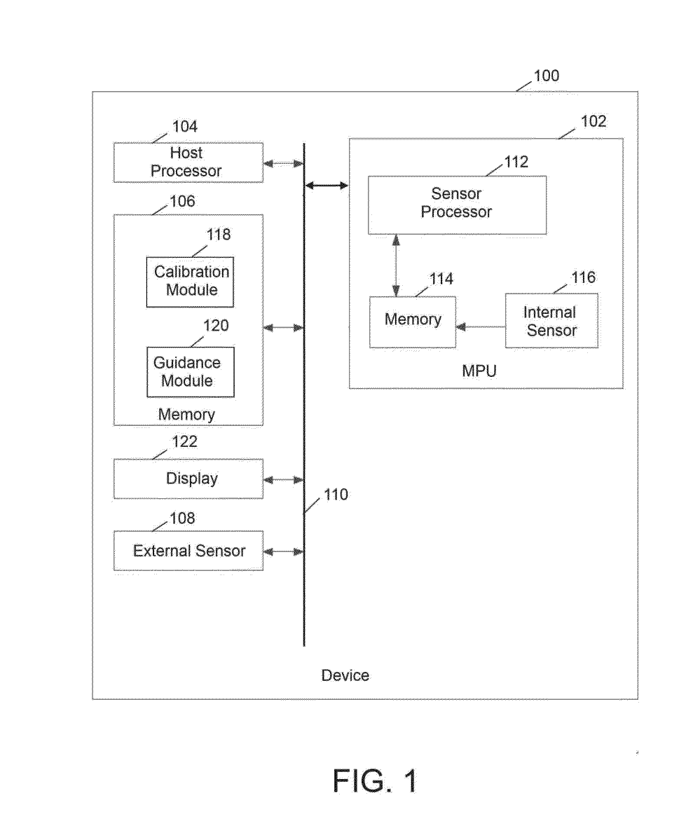

Details regarding one embodiment of a mobile electronic device 100 exhibiting features of this disclosure are depicted as high level schematic blocks in FIG. 1. As will be appreciated, device 100 may be implemented as a device or apparatus, such as a handheld device that can be moved in space by a user and its motion and/or orientation in space therefore sensed. For example, such a handheld device may be a mobile phone (e.g., cellular phone, a phone running on a local network, or any other telephone handset), wired telephone (e.g., a phone attached by a wire), personal digital assistant (PDA), tablet, video game player, video game controller, navigation device, mobile internet device (MID), personal navigation device (PND), digital still camera, digital video camera, binoculars, telephoto lens, portable music, video, or media player, remote control, or other handheld device, or a combination of one or more of these devices.

In some embodiments, device 100 may be a self-contained device that includes its own display and sufficient computational and interface resources to generate and display the virtual three dimensional environment. However, in other embodiments, device 100 may function in conjunction with another portable device, such as one of those noted above, or a non-portable device such as a desktop computer, electronic tabletop device, server computer, etc., either of which can communicate with device 100, e.g., via network connections. Device 100 may be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections.

Therefore, device 100 may include at a minimum one or more motion sensors that may be calibrated such that the virtual three dimensional environment may be responsive to movements and orientations of device 100. Other functions associated with this disclosure that will described in more detail below, such as generating and updating the virtual three dimensional environment, displaying the virtual three dimensional environment, interfacing with the calibration operation, as well as others, may be implemented either in device 100 or an additional device as desired and depending on the relative capabilities of the respective devices. As an example, device 100 may be configured as a wearable device, such as a watch, wrist band, ring, pedometer, anklet or the like, and may be used in conjunction with another device, such as a smart phone or tablet, which may be used to provide the display for representing the virtual three dimensional environment. Thus, as used herein, the term “sensor system” means either a self-contained device or a device used in conjunction with another device.

Returning to the exemplary embodiment shown in FIG. 1, device 100 includes MPU 102, host processor 104, host memory 106, and external sensor 108. Host processor 104 may be configured to perform the various computations and operations involved with the general function of device 100. Host processor 104 may be coupled to MPU 102 through bus 110, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. Host memory 106 may include programs, drivers or other data that utilize information provided by MPU 102. Exemplary details regarding suitable configurations of host processor 104 and MPU 102 may be found in co-pending, commonly owned U.S. patent application Ser. No. 12/106,921, filed Apr. 21, 2008, which is hereby incorporated by reference in its entirety.

In this embodiment, MPU 102 is shown to include sensor processor 112, memory 114 and internal sensor 116. Memory 114 may store algorithms, routines or other instructions for processing data output by sensor 116 or sensor 108 as well as raw data and motion data. Internal sensor 116 may include one or more sensors, such as accelerometers, gyroscopes, magnetometers, pressure sensors, microphones and other sensors. Likewise, external sensor 108 may include one or more sensors, such as accelerometers, gyroscopes, magnetometers, pressure sensors, microphones, proximity, and ambient light sensors, and temperature sensors among others sensors. As used herein, an internal sensor refers to a sensor implemented using the MEMS techniques described above for integration with an MPU into a single chip. Similarly, an external sensor as used herein refers to a sensor carried on-board the device that is not integrated into a MPU. In the context of this disclosure, at least one of the internal or external sensors is a motion sensor, such as a gyroscope, an accelerometer or a magnetometer. For example, a typical implementation may feature a gyroscope, an accelerometer and a magnetometer configured as internal sensors 116 and each providing data output corresponding to three orthogonal axes which may utilize a sensor fusion operation to generate a 9-axis attitude (three different sensors for each of the three axes).

In some embodiments, the sensor processor 112 and internal sensor 116 are formed on different chips and in other embodiments; they reside on the same chip. In yet other embodiments, a sensor fusion algorithm that is employed in calculating orientation of device is performed externally to the sensor processor 112 and MPU 102, such as by host processor 104. In still other embodiments, the sensor fusion is performed by MPU 102. More generally, device 100 incorporates MPU 102 as well as host processor 104 and host memory 106 in this embodiment.

As will be appreciated, host processor 104 and/or sensor processor 112 may be one or more microprocessors, central processing units (CPUs), or other processors which run software programs for device 100 or for other applications related to the functionality of device 100. For example, different software application programs such as menu navigation software, games, camera function control, navigation software, and phone or a wide variety of other software and functional interfaces can be provided. In some embodiments, multiple different applications can be provided on a single device 100, and in some of those embodiments, multiple applications can run simultaneously on the device 100. Multiple layers of software can be provided on a computer readable medium such as electronic memory or other storage medium such as hard disk, optical disk, flash drive, etc., for use with host processor 104 and sensor processor 112. For example, an operating system layer can be provided for device 100 to control and manage system resources in real time, enable functions of application software and other layers, and interface application programs with other software and functions of device 100. A motion algorithm layer can provide motion algorithms that provide lower-level processing for raw sensor data provided from the motion sensors and other sensors, such as internal sensor 116 and/or external sensor 108. Further, a sensor device driver layer may provide a software interface to the hardware sensors of device 100.

Some or all of these layers can be provided in host memory 106 for access by host processor 104, in memory 114 for access by sensor processor 112, or in any other suitable architecture. For example, in some embodiments, host processor 104 may read instructions and data from calibration module 118 in host memory 106 to perform a calibration operation for at least one of internal sensor 116 or external sensor 108. Further, in this embodiment, host memory 106 also includes guidance module 120 configured to generate the virtual three dimensional environment used for prompting the user to move and position device 100 as desired and to interface with calibration module 118. A system that utilizes calibration module 118 and guidance module 120 in accordance with the present disclosure may take the form of an entirely hardware implementation, an entirely software implementation, or an implementation containing both hardware and software elements. In one implementation, calibration module 118 and/or guidance module 120 may be implemented in software, which includes, but is not limited to, application software, firmware, resident software, microcode, etc. Furthermore, calibration module 118 and/or guidance module 120 may take the form of a computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate, or transport the program for use by or in connection with the instruction execution system, apparatus, or device.

Device 100 may also include display 122 adapted to represent the virtual three dimensional environment generated by guidance module 120. Device 100 may also include any suitable mechanisms for effecting input and/or output to a user, such as audio speakers, buttons, switches, a touch screen, a joystick, a trackball, a mouse, a slider, a knob, a printer, a scanner, a camera, or any other similar components. Further, device 100 may include one or more communication modules for establishing a communications link, which may employ any desired wired or wireless protocol, including without limitation WiFi®, cellular-based mobile phone protocols such as long term evolution (LTE), BLUETOOTH®, ZigBee®, ANT, Ethernet, peripheral component interconnect express (PCIe) bus, Inter-Integrated Circuit (I2C) bus, universal serial bus (USB), universal asynchronous receiver/transmitter (UART) serial bus, advanced microcontroller bus architecture (AMBA) interface, serial digital input output (SDIO) bus and the like.

As indicated above, a calibration operation may benefit from placing device 100 in a desired orientation or by moving device 100 through a defined pattern of movement. For the purposes of illustration and not limitation, one of skill in the art will appreciate that the following different types of calibration operations that are performed for different sensors may benefit from specific orientations and movements. Calibrating the bias of an accelerometer may be facilitated by performing slow rotations of device 100 along at least two axes with periodic periods of motionlessness. By providing movement on at least two axes, deviation from a single plane of reference may be achieved. Calibrating the hard iron bias of a magnetometer may be facilitated by rotation along at least two axes. Calibrating the soft iron bias of a magnetometer may be facilitated by movement that results in a reference from the device projected into space and covering a sphere surrounding the device, essentially resulting from moving device 100 through complete rotations with three degrees of freedom. Other calibration operations involving other sensors may also benefit from this pattern of motion. Calibrating the bias of a gyroscope may be facilitated by slow rotation or by motionlessness. Calibrating the sensitivity of a gyroscope may be facilitated by slow rotation, such as approximately 90°, along three axes. Likewise other calibration operations involving the same or other sensors may benefit from other orientations or patterns.

Given a desired orientation or pattern of movement that may be configured to facilitate a particular calibration operation, guidance module 120 may be used to generate a virtual three dimensional environment that may be represented to a user via display 122 in response to an orientation of device 100 as determined using one or more of internal sensor 116 and/or external sensor 108. Generation of animated virtual three dimensional environments may be achieved as known in the art, for example by using techniques that have been developed for computerized gaming, including genres such as first-person shooters or flight simulators. Accordingly, the generated virtual three dimensional environment may be used to provide the user a visual cue that results in device 100 being positioned in a desired orientation. Once device 100 has been positioned in the desired orientation, guidance module 120 may provide an indication to the user of successful orientation in any suitable manner. For example, the virtual three dimensional environment may be updated to provide a visual indication, or an auditory or tactile (e.g., vibration) may be used.

As noted, the virtual three dimensional environment may be responsive to a determined orientation of device 100, such as by updating the visual on display 122 to reflect any change in orientation. Thus, after successful positioning with respect to a first desired orientation, guidance module 120 may provide one or more additional visual cues associated with one or more additional desired orientations. By providing a plurality of visual cues in an appropriate order, any desired pattern of motion may be recreated.

In a further aspect, calibration module 118 may interface with guidance module 120 during the calibration operation. For example, the choice and sequence of visual cues may be prompted by calibration module 118 according to the operation being performed and the type of sensor being calibrated. Additionally, indications of quality and/or progress may be conveyed from calibration module 118 to guidance module 120, allowing guidance module 120 to adapt the sequence of visual cues in an appropriate manner. For example, if a given stage of the calibration operation is identified as having poor quality, guidance module 120 may be configured to repeat a portion of the visual cues. Likewise, once calibration module 118 determines the sensor has been successfully calibrated, it may convey that information to guidance module 120 which may then terminate the routine. The interface between calibration module 118 and guidance module 120 may also be configured to give the user an indication of how closely the desired orientation or pattern of motion was matched, thereby providing feedback that may allow the user to improve.

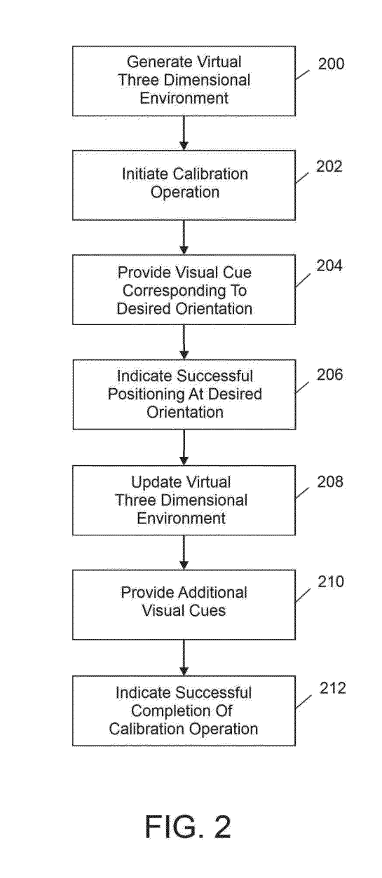

To help illustrate aspects of this disclosure, an exemplary routine for guiding a user during calibration of device 100 is represented by the flowchart shown in FIG. 2. Beginning in 200, guidance module 120 may initiate the routine by generating the virtual three dimensional environment, for example, in response to a predetermined schedule, upon a determination that a sensor is miscalibrated, upon prompting by the user, or as a reaction to any other suitable trigger event. A suitable calibration operation may be initiated by calibration module 118 in 202. Next, in 204 guidance module 120 may provide a first visual cue configured to aid the user in positioning device 100 in a first desired orientation. After determining that positioning has been achieved with respect to the first desired orientation, guidance module 120 may indicate success to the user in any suitable manner in 206. Guidance module 120 may then update the virtual three dimensional environment in response to device 100 being positioned in the first orientation in 208. As will be appreciated, 206 and 208 may be performed at the same time and may represent the same action. Next, guidance module 120 may provide one or more additional visual cues associated with one or more additional desired orientations in 210. As described above, an appropriate sequence of desired orientations may result in a defined pattern of motion configured to facilitate a calibration operation. Finally, in 212 guidance module 120 may signal the user that the calibration has been successfully performed when calibration module 118 completes the operation.

Any number of virtual three dimensional environments may be employed to implement the techniques of this disclosure and the following material discusses embodiments that are intended to indicate currently-envisioned possibilities and should not be considered limiting.

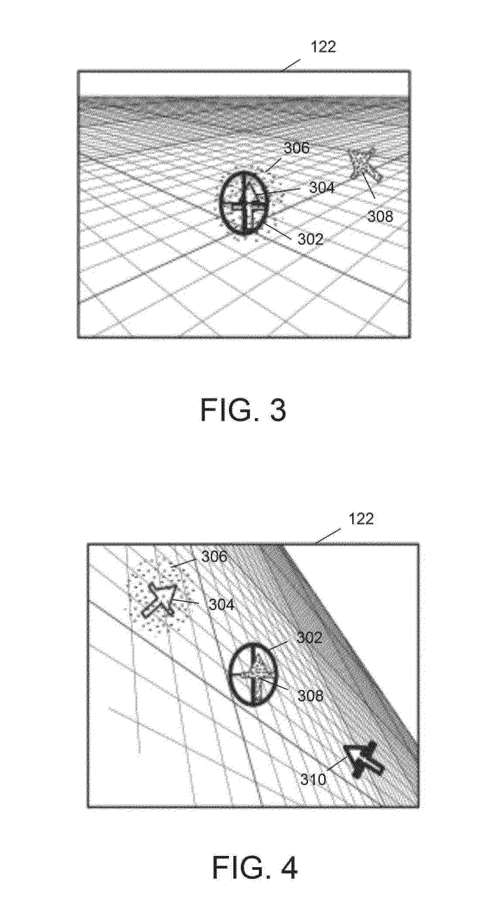

One suitable embodiment of a virtual three dimensional environment is depicted in reference to FIGS. 3 and 4. These figures represent images that may be generated by guidance module 120 and shown on display 122 as visual cues to aid the user in positioning device 100 in desired orientations. In FIG. 3, a view showing the virtual three dimensional environment is provided with reticule 302 currently aligned over a first target object 304. As shown, target object 304 may include an orientation indicator, in this embodiment, an arrow. Thus, device 100 may be oriented so that the cross hairs of reticule 302 are over object 304 and may further be rotated about the axis created between the cross hairs and the object so that arrow points up. In the view of FIG. 3, the cross hairs of reticule 302 are aligned and the arrow of object 304 is pointing up, representing that device 100 has been positioned in a desired orientation. Guidance module 120 indicates this to user by providing an aura 306 around object 304. As noted above, any suitable visual, auditory or tactile indication may be employed as desired. Further, guidance module 120 is providing another visual cue in the form of target object 308, which is not currently aligned with reticule 302. In this example, the process of positioning at a desired orientation corresponding to target object 308 may involve rotating device 100 around the axis to target object 308 as its arrow is not currently pointing up. Correspondingly, the view shown in FIG. 4 represents device 100 being nearly positioned at the new desired orientation, so that the cross hairs of reticule 302 are almost aligned with object 308 and the arrow is pointing up. The previously aligned object 304 is also shown, including aura 306 to indicate that the orientation associated with object 304 has been achieved. Upon successful alignment and orientation, a similar aura may be added to object 308. Further, target object 310 may represent yet another desired orientation to be positioned after object 308. As an example, the current target object, object 308 may be displayed in one color and any subsequent objects, such as object 310, may be displayed in another color. Similarly, rather than adding an aura, such as aura 306, the color of the target object may be changed or any other suitable indication of successful positioning or correct sequencing may be given.

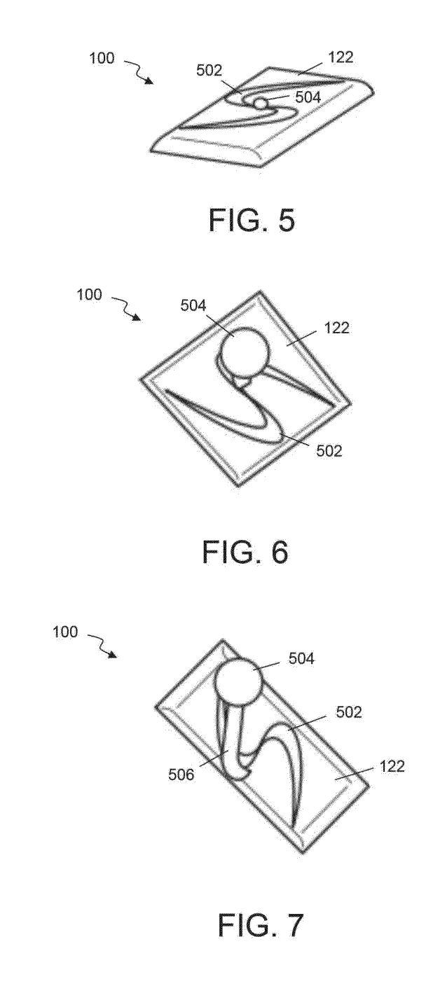

Another suitable embodiment of a virtual three dimensional environment is depicted in reference to FIGS. 5-7. In these figures, device 100 is being moved through various orientation as indicated. Display 122 shows an image of a three dimensional conduit 502 generated by guidance module 120 that conceptually may be considered to be fixed to the body frame of device 100. Guidance module 120 may also generate reference object 504 to represent a ball or the like that may be guided within conduit 502. Movement of object 504 may be controlled by positioning device 100 in various orientations. For example, object 504 may be considered to be affected by a gravity force within the generated virtual three dimensional environment, such that tilting device 100 along an axis that is perpendicular to conduit 502 at the location of object 504 may result in the object moving through the conduit. In contrast, tilting device 100 along an axis that is parallel to conduit 502 at the location of object 504 may not result in movement of the object. Thus, the shape of conduit 502 generated by guidance module 120 may require the user to tilt device 100 in such a manner that a desired orientation or pattern of motion is recreated. Successfully navigating a portion of conduit 502, and therefore successful positioning of device 100 in one or more desired orientations, may be indicated by guidance module 120 by trail 506 that is left behind object 504.

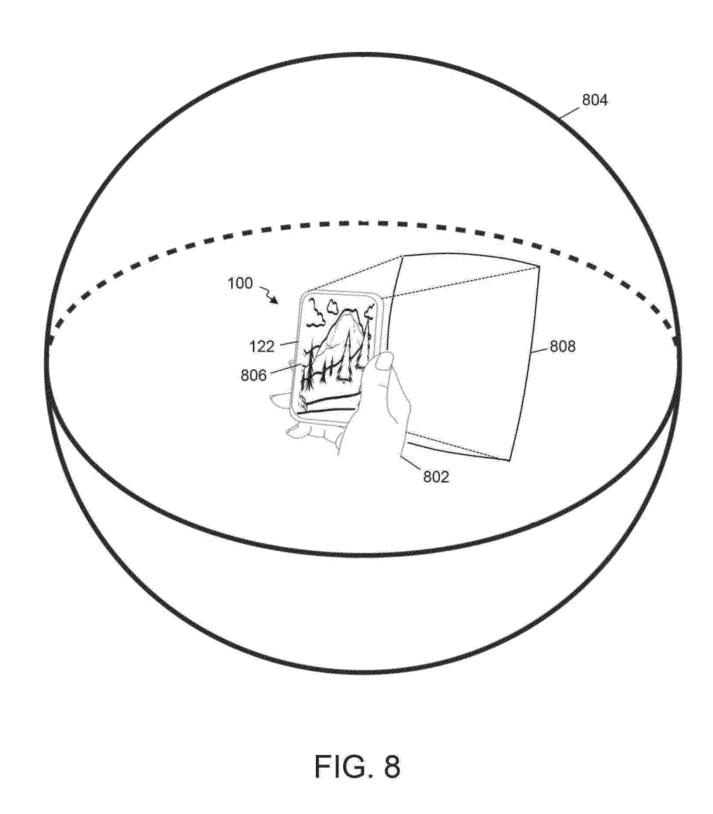

Yet another suitable embodiment of a virtual three dimensional environment is depicted in reference to FIG. 8. As shown, device 100 is being held in a first orientation by user hand 802. Guidance module 120 generates a virtual three dimensional environment schematically represented as sphere 804 having an associated panoramic image on its interior surface. Conceptually, device 100 may be considered to act as a virtual camera by showing an image 806 on display 122 that corresponds to a portion 808 of spherical panoramic image. In one aspect, a desired pattern of motion may be recreated by guidance module 120 providing a moving reference object in the spherical panoramic image for the user to track with device 100. In another aspect, guidance module 120 may be configured to lead the user through positioning device 100 through complete rotations with three degrees of freedom with respect to sphere 804 by updating the image in response to being visualized with the virtual camera. For example, when portion 808 is shown on display 122, it may be updated in response, such as by changing from black and white to color, by transitioning from out-of-focus to in-focus, or through any other suitable indication. By changing the way the image is presented, the user may quickly determine which portions of inner surface of sphere 804 have been visualized and which portions have not. In this manner, the user may be guided through a series of orientations of device 100 by pointing at all or a substantial portion of the interior surface of sphere 804.

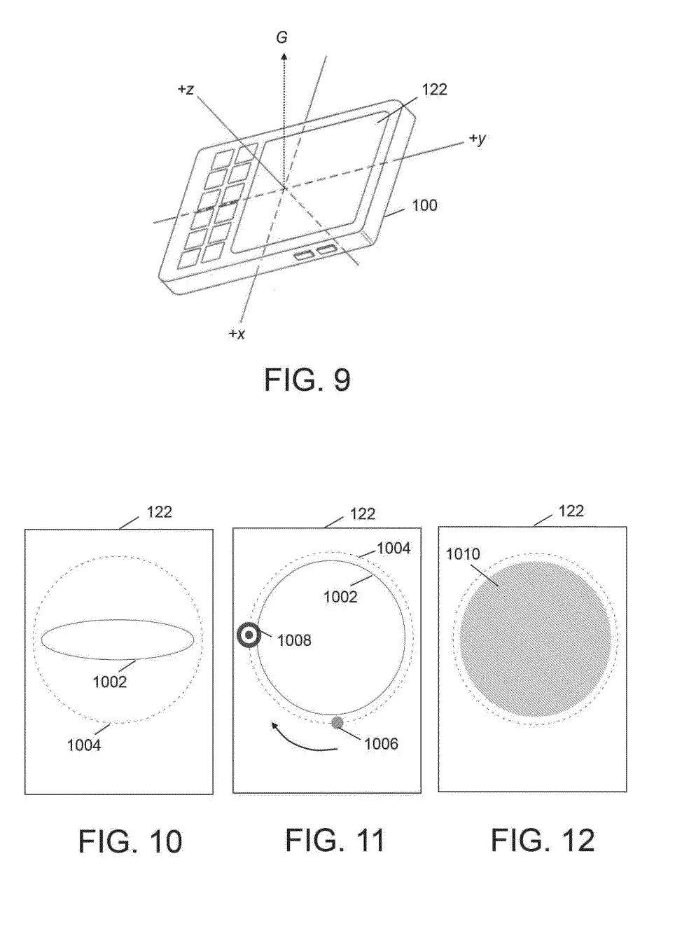

Another exemplary embodiment may be described in the context of FIGS. 9-12. Beginning with FIG. 9, the orientation of device 100 is schematically represented as having three body axes, x, y and z that may have an orientation with respect to an external frame of reference, such as a world coordinate frame having a gravity vector G as shown. In one aspect, guidance module 120 may generate a virtual three dimensional environment configured to facilitate calibration of an accelerometer. A suitable routine may begin with the user positioning device 100 in an initial orientation, such as face up on a flat surface. In FIG. 10, guidance module 120 may generate a reference circle 1002 that is orthogonal to gravity. Correspondingly, guidance module 120 may also generate device circle 1004 to represent the orientation of device 100. In this example, device circle 1004 may be orthogonal to the z axis of the body frame. Guidance module 120 may prompt the user to align the device circle 1004 with the reference circle 1002 as shown in FIG. 11. Guidance module 120 may also generate a orientation object 1006 to direct the user to position device 100 in one or more desired orientations. For example, orientation object 1006 may be configured to act as though it is pulled by gravity to the “lowest” position on device circle 1004. Guidance module 120 may indicate a target 1008 to direct the user to reorient device 100. As shown, a counter clockwise rotation of device 100 would result in a clockwise movement of orientation object 1006 towards target 1008 as indicated. The user may then hold device 100 in that orientation until calibration module 118 gathers sufficient data. Guidance module 120 may then generate a new target corresponding to the next desired orientation. In one aspect, targets may be provide at locations corresponding to the +x, −x, +y and −y axes. After device 100 has been held motionless in a sufficient number of orientations for calibration module 118 to complete the routine, guidance module 120 may then indicate successful calibration, such as by displaying device circle 1004 as filled with color 1010 as shown in FIG. 12, or through any other suitable indication.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for calibrating a motion sensor of a device comprising:
generating a virtual three dimensional environment;
displaying a first visual cue to a user with respect to the virtual three dimensional environment configured to guide the user to position the device in a first desired orientation; and
providing an indication to the user when the device is positioned in the first desired orientation.

2. The method of claim 1, further comprising updating the virtual environment in response to the user moving the device to the first desired orientation.

3. The method of claim 2, further comprising displaying at least a second visual cue configured to guide the user to move the device from the first desired orientation to a second desired orientation.

4. The method of claim 1, further comprising displaying a plurality of visual cues configured to guide the user to position the device in a sequence of desired orientations.

5. The method of claim 4, wherein the sequence of desired orientations is configured to result in a desired pattern of motion.

6. The method of claim 5, wherein the desired pattern of motion results from complete rotations in three degrees of freedom.

7. The method of claim 5, wherein the motion sensor is an accelerometer and wherein the desired pattern of motion is configured to incorporate relatively slow rotation around at least two axes of the device with periodic periods of motionlessness.

8. The method of claim 5, wherein the motion sensor is a magnetometer and wherein the desired pattern of motion is configured to incorporate rotation around at least two axes of the device.

9. The method of claim 5, wherein the motion sensor is a gyroscope and wherein the desired pattern of motion is configured to include a period of motionlessness in the first desired orientation.

10. The method of claim 5, wherein the motion sensor is a gyroscope and wherein the desired pattern of motion is configured to incorporate rotation around three axes of the device with periods of motionlessness.

11. The method of claim 1, further comprising providing an indication to the user when the device is sufficiently calibrated.

12. The method of claim 1, wherein the virtual three dimensional environment comprises a panorama.

13. The method of claim 1, wherein the first visual cue comprises a target object within the virtual three dimensional environment.

14. The method of claim 1, wherein the first visual cue comprises an object within the virtual three dimensional environment that moves in response to an orientation of the device.

15. A sensor system comprising:
a device having at least one motion sensor; and
a guidance module configured to:
generate a virtual three dimensional environment;
display a first visual cue to a user with respect to the virtual three dimensional environment configured to guide the user to position the device in a first desired orientation; and
provide an indication to the user when the device is positioned in the first desired orientation.

16. The sensor system of claim 15, wherein the guidance module is configured to update the virtual environment in response to the user moving the device to the first desired orientation.

17. The sensor system of claim 16, wherein the guidance module is configured to display at least a second visual cue to guide the user to move the device from the first desired orientation to a second desired orientation.

18. The sensor system of claim 15, wherein the guidance module is configured to display a plurality of visual cues configured to guide the user to position the device in a sequence of desired orientations.

19. The sensor system of claim 18, wherein the sequence of desired orientations is configured to result in a desired pattern of motion.

20. The sensor system of claim 19, wherein the desired pattern of motion results from complete rotations in three degrees of freedom.

21. The sensor system of claim 19, wherein the motion sensor is an accelerometer and wherein the desired pattern of motion is configured to incorporate relatively slow rotation around at least two axes of the device with periodic periods of motionlessness.

22. The sensor system of claim 19, wherein the motion sensor is a magnetometer and wherein the desired pattern of motion is configured to incorporate rotation around at least two axes of the device.

23. The sensor system of claim 19, wherein the motion sensor is a gyroscope and wherein the desired pattern of motion is configured to include a period of motionlessness in the first desired orientation.

24. The sensor system of claim 19, wherein the motion sensor is a gyroscope and wherein the desired pattern of motion is configured to incorporate rotation around three axes of the device with periods of motionlessness.

25. The sensor system of claim 15, wherein the guidance module is configured to provide an indication to the user when the device is sufficiently calibrated.

26. The sensor system of claim 15, wherein the virtual three dimensional environment comprises a panorama.

27. The sensor system of claim 15, wherein the first visual cue comprises a target object within the virtual three dimensional environment.

28. The sensor system of claim 15, wherein the first visual cue comprises an object within the virtual three dimensional environment that moves in response to an orientation of the device.
